(19) United States
(12) Patent Application Publication
(10) Pub. No.: US 2004/0197172 A1
(43) Pub. Date: Oct. 7, 2004

(54) Transfer car for loading and unloading transported goods

(76) Inventors: Rudolf Hansl, Altmunster (AT); Markus Rohrauer, St Florian (AT)

Correspondence Address: WILLIAM COLLARD, COLLARD & ROE, P.C., 1077 NORTHERN BOULEVARD, ROSLYN, NY, 11576, US

(21) Appl. No.: 10/482,898

(22) PCT Filed: Jul. 3, 2002
(86) PCT No.: PCT/AT02/00193

(30) Foreign Application Priority Data
Jul. 4, 2001 (AT) GM 534/01

(51) Int. Cl. B65G 1/00

(52) U.S. Cl. 414/281

(57) ABSTRACT

The invention relates to a method of storing and retrieving load-bearing units (16) and a conveyor trolley with a load-bearing means (12) to accommodate a trolley (21), having a platform (40) for receiving a load-bearing unit (16), in particular a pallet, as and when necessary, which is equipped with bogie assemblies (30) with height and lateral guide elements (31) for storing and retrieving the load-bearing unit (16), and the height guide elements (31) are displaceable along at least one guide track (23) on the load-bearing means (12) and are linked to at least one displacement drive (30) to initiate the displacement motion of the load-bearing means (12), and the displaceable platform (40) is linked to a drive (41). The height guide elements (31) co-operate with at least one displacement mechanism (48), which has a first non-operating position in which the height guide elements (31) of the trolley (21) are supported on the height guide tracks (32), and at least one other conveying position in which the height guide elements (31) are disengaged from the height guide tracks (32), and the height guide elements (31) displaceably bear and support at least one load-bearing unit (16) by means of the displacement drive (39) as and when necessary.

The invention relates to a conveyor trolley, in particular a shelf-stacking device, and a method of storing and retrieving pallets by means of a conveyor trolley of this type, as outlined in the generic parts of claims 1, 35, 36 and 41.

A system is already known whereby an additional trolley is provided on a load-bearing means for storing or retrieving load-bearing units on a conveyor trolley, in particular a shelf-stacking device, on which the load-bearing units are disposed. This additional trolley is used for stowing and retrieving the load-bearing units in the racking bay. To this end, these trolleys are equipped with a displacement drive to operate the displacement and a drive to operate the lifting and lowering movement. A distributor vehicle of this type is known from patent specifications DE 42 10 175 A1 and GB 1 204 044 B, for example. The disadvantage of these known conveyor trolleys with a separate trolley is that the racking system must be specifically and exactly adapted to operate in conjunction with the design of the conveyor trolley. Furthermore, the pallets to be conveyed must be deposited on the conveyor trolley, directly on a platform, by means of their longitudinal spars, which means that the maximum stroke height of the load-bearing means is restricted, depending on the structural design of the pallets, which makes utilisation of the available space in the racking system less efficient, on the one hand, and, on the other, robust positioning mechanisms have to be provided for holding the pallet, at least as it is being transported.

The objective of the present invention is to propose a conveyor trolley with a trolley which requires a very low structural height in which to accommodate the trolley, and/or racking systems of different designs can be serviced by means of conveyor trolleys of this type.

This objective is achieved by the invention in the manner defined in claim 1. The advantage of this conveyor trolley is that the option of using height guide elements on the trolley enables stowage spaces in the racking system to be filled even though the trolley can not be moved into them, because the height guide elements of the trolley are used to deposit the; load-bearing units, in particular pallets, in such situations, whilst in a racking system that is equipped accordingly, the load-bearing elements can be moved directly into their respective position by means of the trolley. In addition, because of the dual function of the conveyor trolley, the transfer time at adjoining conveyor sections, e.g. roller conveyors, opposite shelf-stacking devices at which the load-bearing units also have to be transferred from the shelf-stacking device to a downstream conveyor system by means of the conveyor trolley, is significantly reduced. This makes for a considerable saving in running time or cycle time, whilst simultaneously affording the advantage of being able to make additional use of a trolley on a shelf-stacking device of this type.

Also of advantage is an embodiment as defined in claim 2, since it enables a relative displacement of the trolley relative to its guide tracks on the shelf-stacking device or conveyor trolley, in which case the height guide elements can optionally be used for transporting the load-bearing units or for moving the trolley.

The embodiment defined in claim 3 also gives the trolley versatility, obviating the need to provide additional equipment on the shelf-stacking device.

As defined in claim 4, it is also of advantage if the height of the actual height guide elements can be adjusted and thus moved into different positions for different functions.

A simple solution is also described in claim 5, since the load-bearing unit is guided at several points during the guiding and moving process.

The embodiment defined in claim 6 provides a simple means of adjusting to different storage and retrieval heights and does so both in the area where the pallets are deposited and picked up and during the process of depositing them in the shelves of the racking bay, because different guide heights for the trolley can be easily set up on existing racking systems.

Also of advantage is another embodiment defined in claim 7, whereby the trolley can be specifically positioned relative to the load-bearing means in readiness for specific functions.

Advantages are also to be had from another embodiment defined in claim 8, whereby the retaining means for the trolley can be simultaneously used for changing the function of the height guide elements.

The embodiment defined in claim 9 is of advantage because it significantly simplifies the process of manipulating load-bearing units and the running time or turnaround time which elapses before a load-bearing unit disposed on the trolley can be replaced by a new load-bearing unit is significantly reduced.

The turnaround time of the load-bearing unit can be accelerated still further as a result of the embodiment defined in claim 10.

Also of advantage is an embodiment as defined in claim 11, because when the bogie assemblies are in the conveying position, several load-bearing units can be handled on the trolley simultaneously, which improves turnaround efficiency in the transfer and pick-up region and, in the broader sense, of the order picking system as a whole.

Another advantageous embodiment is defined in claims 12 to 14, whereby heavy weights can be moved with a displacement mechanism of this type but with a short stroke, making it easier to oversee drive performance.

It is of advantage to provide the displacement mechanism with drive elements as defined in claim 15 because part-regions of the load-bearing unit can be placed with their full surface on the conveyor tracks of the trolley in a conveying position.

Other advantageous embodiments of the displacement mechanism and the displacement drive are described in claims 16 to 18. Due to the extensive range of possible drive modes and the fact of combining several drives for a same function, the shelf-stacking devices can be readily adapted and inexpensively equipped for different types of use, such as handling different intrinsic weights or operating at different speeds, for example.

Also of advantage is an embodiment of the trolley defined in claim 19 since the structural design prevents the load from shifting relative to the trolley and there is no need to take extra safety precautions.

The advantage of the embodiment defined in claim 20 is that it provides a continuous guiding action for the load-bearing unit.

Another embodiment defined in claim 21 is of advantage because it simplifies the task of guiding and stowing the load-bearing unit. In addition, the racking system can be designed with a lower structural height because a part of the construction height of the trolley can be disposed between the longitudinal spars or spacers of the load-bearing unit.

As a result of the embodiment defined in claim 22, the load-bearing unit can be placed in a fixed position on the trolley so that the trolley can be displaced into different operating positions irrespective of the load-bearing unit. The embodiment defined in claim 23 makes for a load-bearing means and trolley of a low construction height.

The embodiment defined in claim 24 provides an easy means of moving the load-bearing unit by the regions where it is stronger due to the longitudinal spars, in other words by engaging with the support surfaces.

The embodiment defined in claim 25 advantageously enables the load-bearing unit to be directly manipulated in readiness for despatching it to adjoining conveyor sections or conveyor tracks without having to move the trolley, thereby reducing the handling time involved in picking up and depositing load-bearing units on adjoining conveyor sections or conveyor tracks. Since the platform engages between the longitudinal spars, the shelves of the racking system may be designed to a significantly lower height because a clearance height of the trolley receiving the pallet is of small in terms of its height and width dimensions.

A simpler structural design and a higher load-bearing capacity can be achieved in terms of construction as a result of the embodiment defined in claim 26. Consequently, the two electrically linked trolleys disposed on the load-bearing means can always be kept at the same height along the sections on the load-bearing means and well as in the stowage spaces of the shelf in order to drive at least one load-bearing unit along.

Another embodiment defined in claim 27 permits the use of standardised components which are easy to produce, thereby making the guide tracks inexpensive to manufacture. The advantage of the embodiment defined in claim 28 is that shifting relative to the trolley can be prevented, even if the load-bearing unit is displaced more rapidly.

The embodiment defined in claim 29 counteracts rocking of the load-bearing unit relative to the trolley.

The design of the power and data supply to the trolley carriage can be further simplified as a result of the embodiments defined in claims 30 to 34.

The objective of the invention is also achieved as a result of the method defined in claim 35. The advantage of this approach is that because the trolley has a dual function, once a load-bearing unit has been transferred in the transfer and pick-up region, it is always ready to receive another load-bearing unit, which significantly reduces transfer times and the conveyor trolley is no longer left standing for unproductive periods. This significantly improves the productivity of the conveyor trolley and using the conveyor trolley proposed by the invention therefore keeps warehousing and turnaround costs to a minimum.

The objective may also be achieved as a result of the features and measures defined in claim 36 and providing the displacement drive in an appropriate design means that force can be supplied in order to push the load-bearing unit along whilst simultaneously picking up a new load-bearing unit without any adverse effect on or reduction in running time, when loading two load-bearing units are being handled.

Also of advantage are the features defined in claims 37 to 40, which offer a whole range of possibilities for optimisation, including running time, because logistical sequences can be operated without requiring any additional effort to integrate other devices, such as lift tables, temporary stowage spaces, etc.

The objective is also advantageously achieved as a result of the features defined in claim 41, whereby optimisation of the displacement times of the load-bearing unit in the transfer and pick-up stations to and from conveyor mechanisms can be significantly accelerated without losing the advantage of easy manipulation of the load-bearing units in the racking system and without requiring much in the way of extra mechanical equipment, such as additional drives, etc.

The invention will be described in more detail with reference to examples of embodiments illustrated in the appended drawings.

Of these:

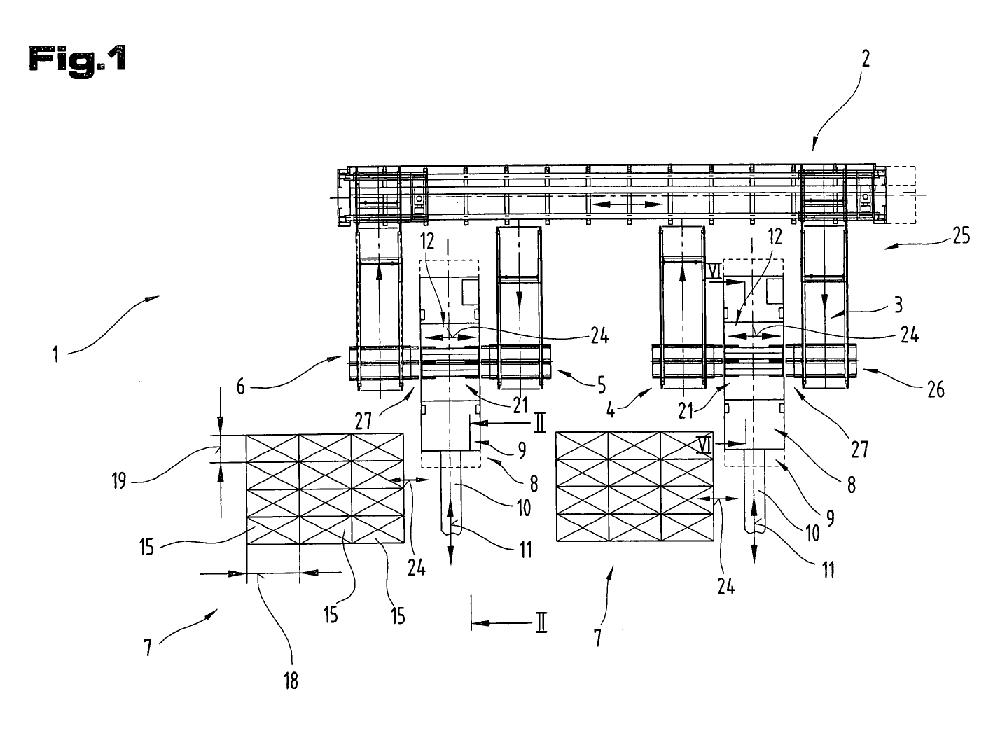

FIG. 1 is a simplified, schematic diagram showing a plan view of an order picking system with several conveyor sections and a conveyor trolley which can be displacement between them and a racking system, in particular a racking bay;

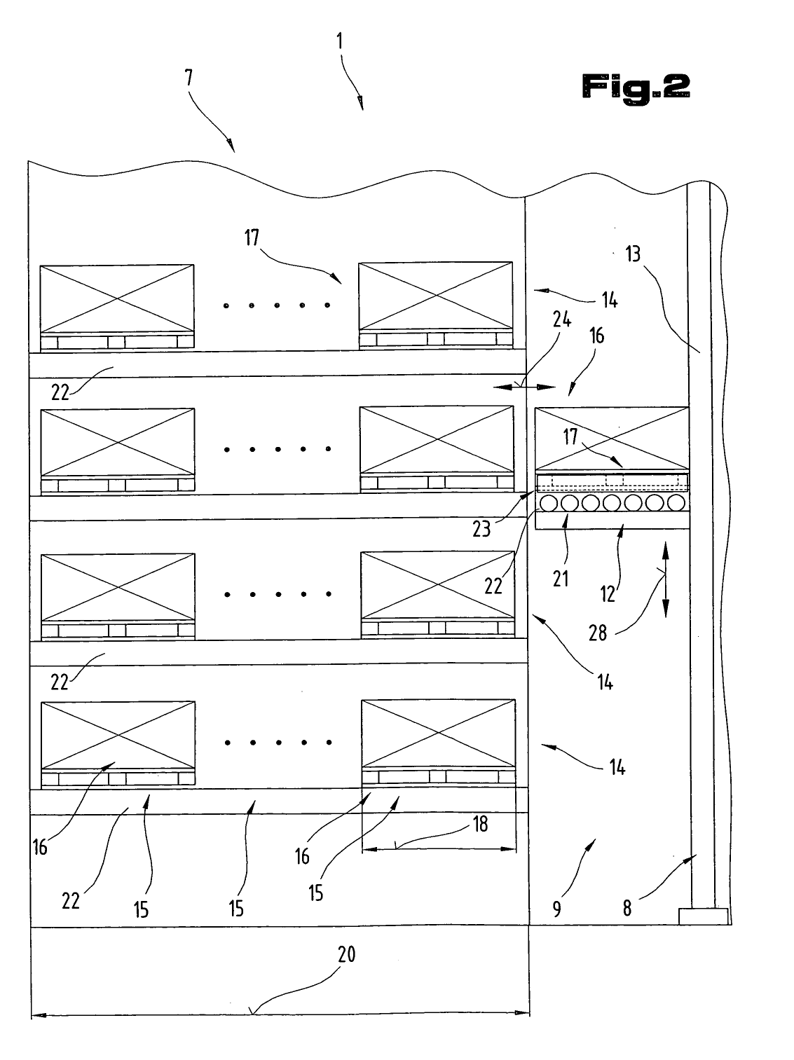

FIG. 2 is a highly simplified, schematic diagram showing the racking system and conveyor trolley in a view along line II-II indicated in FIG. 1;

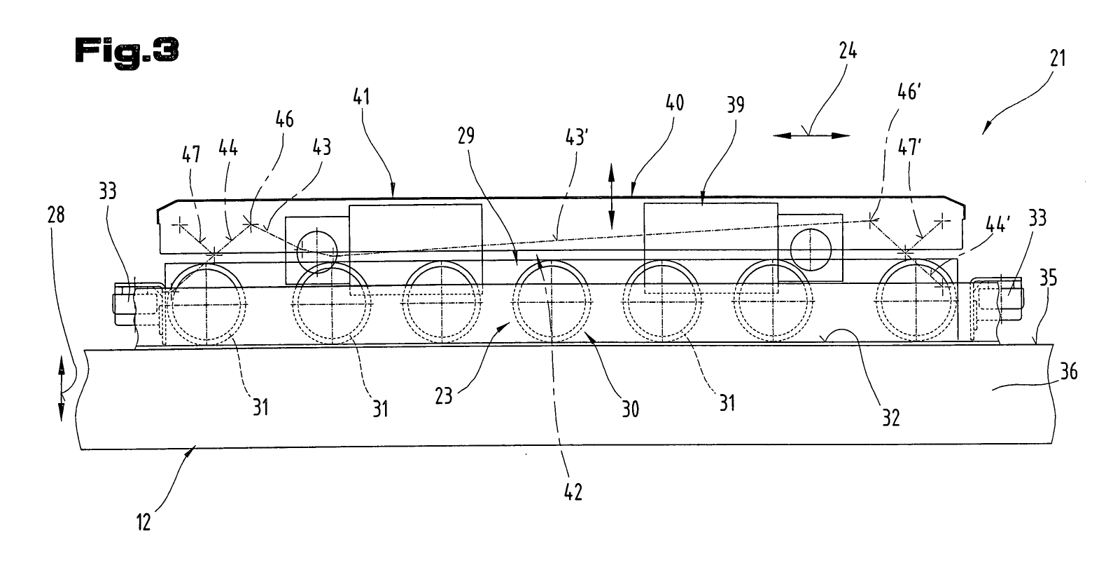

FIG. 3 is a highly simplified, schematic diagram showing a side view of a part-region of the load-bearing means and a trolley disposed in this region with a platform disposed in a lowered position;

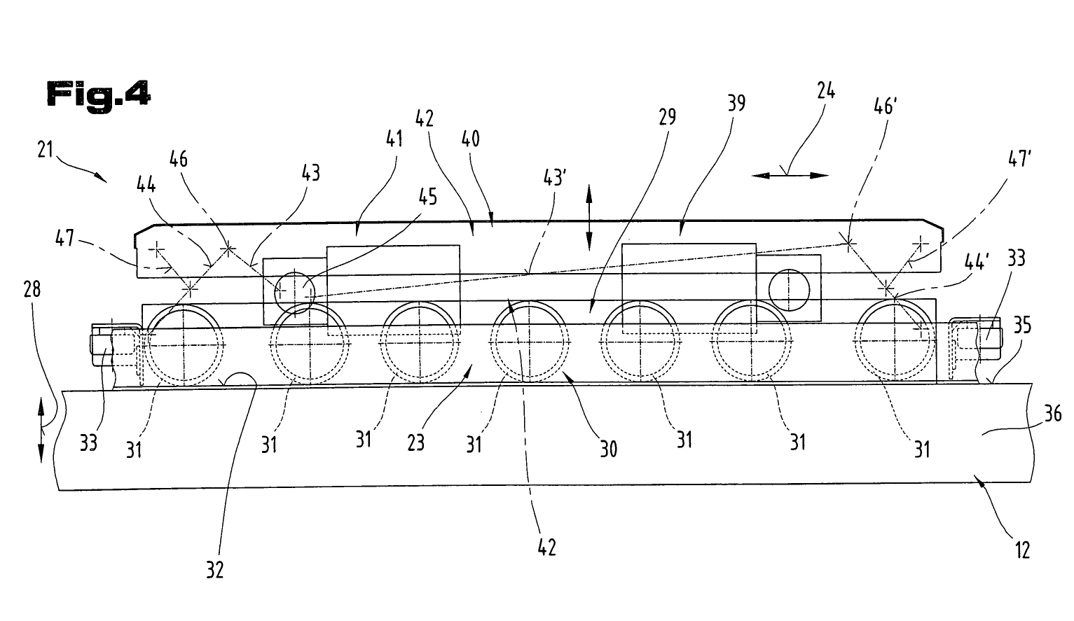

FIG. 4 is a highly simplified, schematic diagram showing a side view of a part-region of the load-bearing means and a trolley disposed in this region with the platform in a raised position;

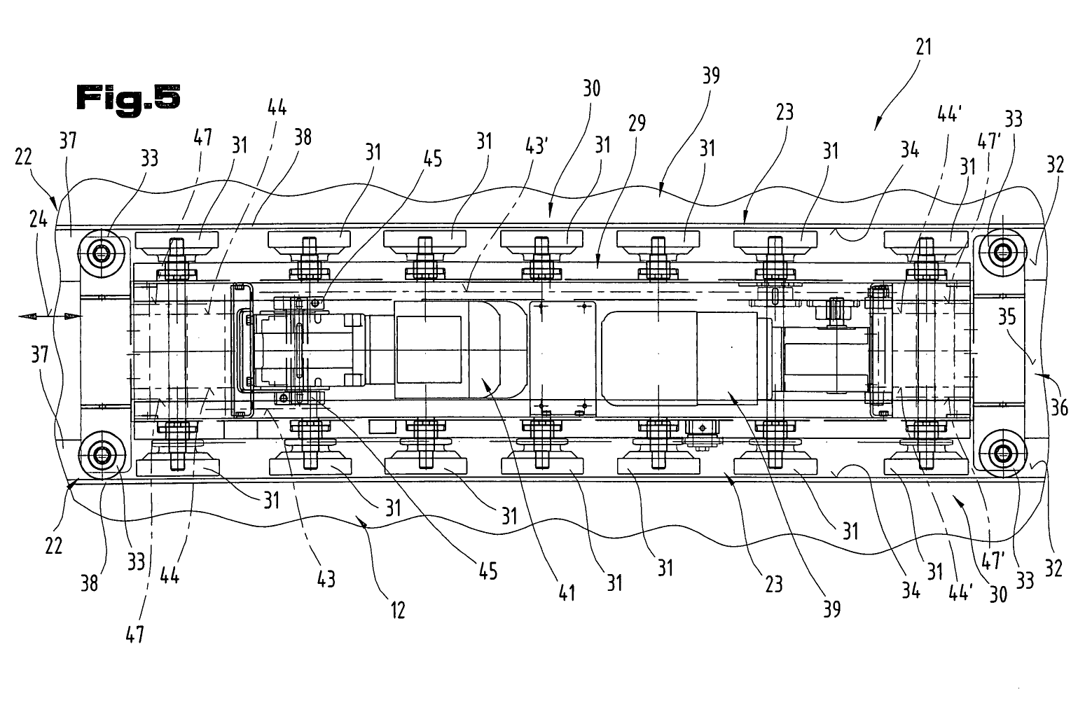

FIG. 5 is a highly simplified, schematic diagram showing a plan view of a part-region of the load-bearing means with the trolley disposed in this region;

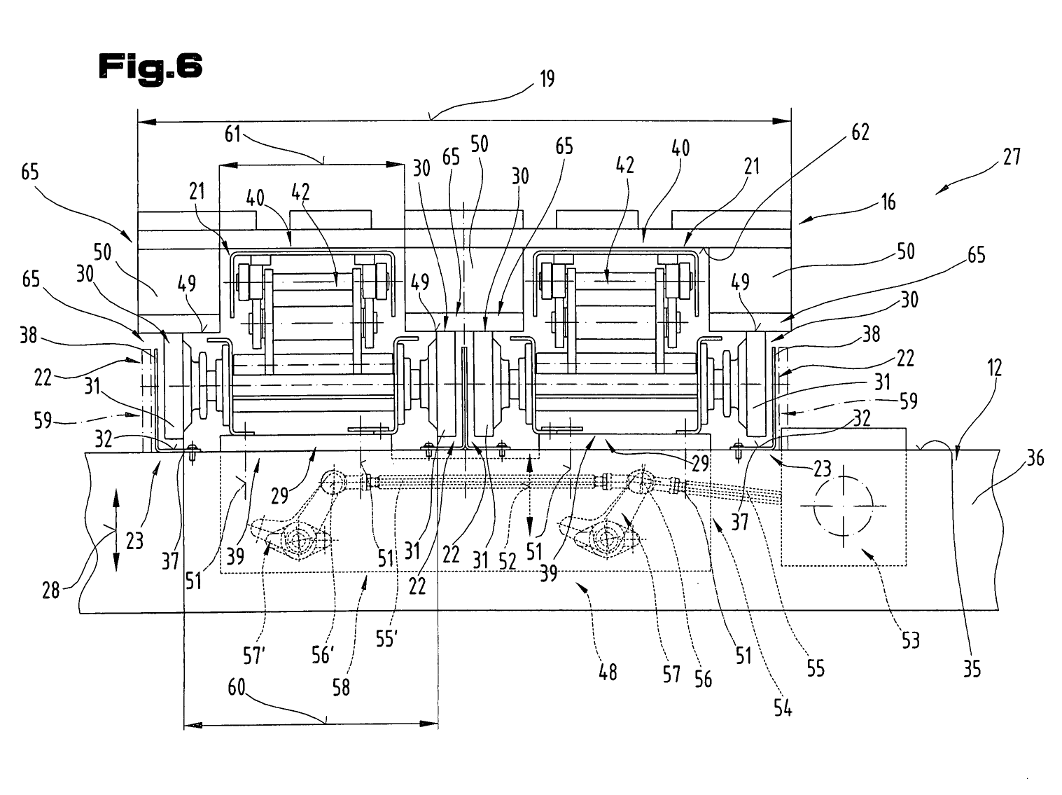

FIG. 6 is a highly simplified, schematic diagram showing a transfer and pick-up area with the trolley in its conveying position in the region of the load-bearing means, seen in partial section along line VI-VI indicated in FIG. 1;

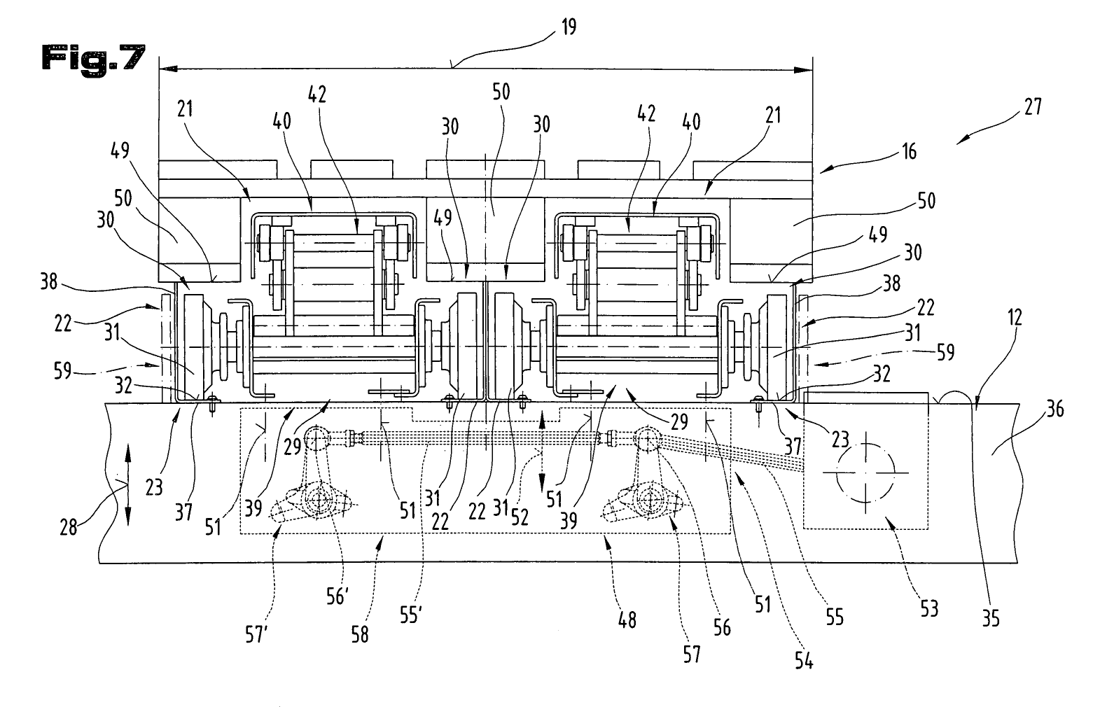

FIG. 7 is a highly simplified, schematic diagram of a transfer and pick-up area with the trolley in its non-operating position in the region of the load-bearing means in the same partial view as that illustrated in FIG. 6;

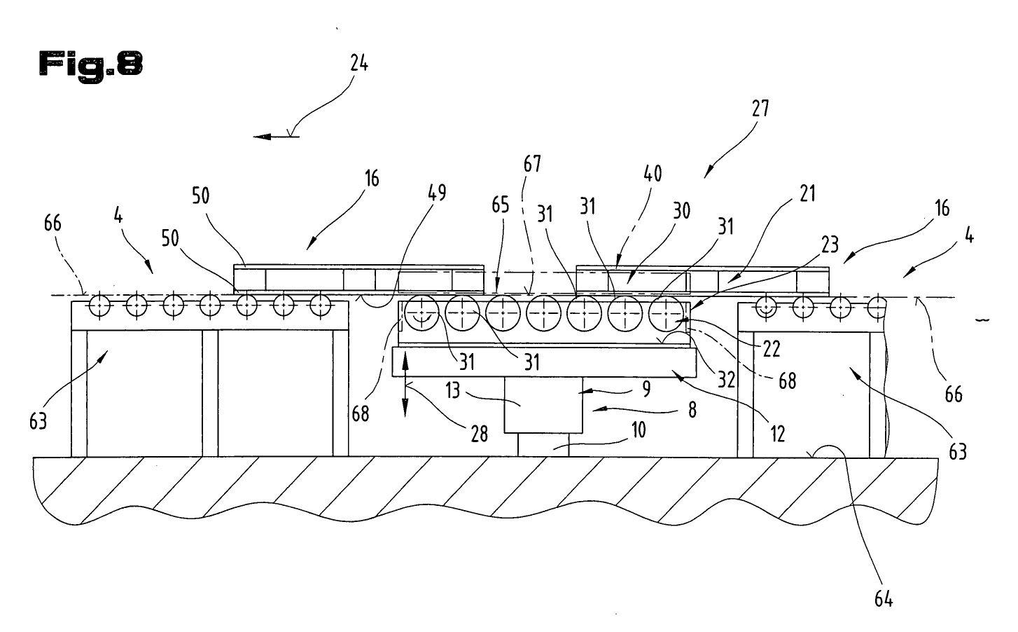

FIG. 8 is a highly simplified, schematic diagram showing a side view of the transfer and pick-up area between conveyor sections and the conveyor trolley, in particular a load-bearing means.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc, relate to the drawing specifically being described and can be transposed in terms of meaning to a new position when another position is being described. Individual features or combinations of features from the different embodiments illustrated and described may be construed as independent inventive solutions or solutions proposed by the invention in their own right.

FIGS. 1 and 2, which will be described together, are highly simplified diagrams showing different view of an example of a layout for an order picking system 1 or part-sections of it, incorporating several conveyor sections 2 to 6 and at least one or, as in these particular drawings, two racking bays 7. Between individual conveyor sections 3, 4; 5, 6 and the racking bays 7, in particular block bays, is at least one conveyor trolley 8, in particular a shelf stacking device 9, which can be displaced directly on the standing surface or—as illustrated—by means of tracks 10 in the aisle direction—indicated by double arrow 11. Shelf stacking devices 9 of this type with a height-adjustable load-bearing means 12 are already known from the prior art and are described in patent specification DE 44 05 952 A1 or DE 195 34 291 A1 or DE 196 14 660 A1 or FR 2 549 814, for example. The load-bearing means 12, displaceable in the height direction of a mast 13, is guided on the mast on at least one guide track by means of height and lateral guide elements, not illustrated, and can be displaced vertically along the guide track by means of a drive system. The racking bay 7 has stowage spaces 14 for load-bearing units 16 in at least one shelf 14. The load-bearing units 16 are specifically provided in the form of pallets with a length 18 that is larger in dimension than their width 19 and preferably made from wood or plastic or metal, etc. The shelves 14 have a depth 20, designed to receive from eight to ten load-bearing units 16, preferably in the form of pallets 17, designed for carrying goods. As may be seen from FIG. 2, the load-bearing means 12 is designed to receive a trolley 21, which has as platform, which will not be described in detail, for receiving the load-bearing unit 16, in particular a pallet 17. The trolley 21 is of a flat design and runs in horizontal, angled sections 22 which, on the one hand, form an integral part of the racking bay 7 and, on the other hand, act as a short guide track 23 for the trolley 21 on the load-bearing means 12. The sections 22 of the racking bay 7 are of a C-shaped or I-shaped design and their bottom flanges serve as a guide track for the trolley 21, whilst their top flanges serve as a depositing surface for the load-bearing unit 16. The sections 22 on the load-bearing means 12, on the other hand, are substantially L-shaped.

The load-bearing units 16 can be stowed one behind the other in the shelves 14 of the racking bay 7, and may be supported on several shelves, disposed one above the other, on the sections 22, in particular on the top flange of the sections 22. By means of the trolley 21, which can be displaced along the sections 22 of the racking bay 7, a load-bearing unit 16 can be stored in and retrieved from a shelf 14 and conveyed from the load-bearing means 12 into the shelf 14 or transferred from the shelf 14 to the load-bearing means 12. The trolley 21 is displaced—as indicated by double arrow 24—transversely to the aisle direction—indicated by double arrow 11—of the conveyor trolley 8. A longitudinal extension of the load-bearing unit 16, in particular the pallet 17, is aligned with its displacement direction—indicated by double arrow 24—and a longitudinal extension of the trolley 21 extends parallel with the load-bearing unit 16 and transversely to the aisle direction—indicated by double arrow 11—of the conveyor trolley 8. A length of the trolley 21 is adapted to the length 18 of the pallet 17. The pallets 17 are stowed in and retrieved from the individual shelves 14 of the racking bay 7 in the direction of their longitudinal extension.

The trolley 21 is moved by the conveyor trolley 8 up to a shelf 14 or lowered therefrom and is moved backwards and forwards in the racking aisle in a predefined manner in the tracks 10 until it reaches the predefined stowage space 15 for storage and retrieval.

As may also be seen from FIG. 1, the racking aisle for the conveyor trolley 8 is bounded in at least certain regions by two conveyor sections 4, 5. The conveyor sections 2 to 6 may be provided in the form of conveyor mechanisms, for example by means of roller conveyors or endlessly circulating conveyors, such as chain conveyors, double belt conveyors, etc., for example. The conveyor sections 2 to 6 constitute a preliminary zone 25, where load-bearing units 16, in particular pallets 17, are individually separated and/or sorted into distributor lines and/or made ready for delivery lines, and the individual load-bearing units 16 are then positioned essentially aligned with the aisle—indicated by double arrow 11—in a direction parallel with the conveyor sections 3; 5 so as to be in a position of readiness 26. When the conveyor trolley 8, in particular the load-bearing means 12, is disposed in a transfer or pick-up area 27 and is between the latter and one of the conveyor sections 3; 4; 5; 6, the trolley 21 may optionally be displaced with or without load-bearing units 16 in one of the conveyor sections 3; 4; 5; 6 and the load-bearing unit 16 fed onwards transversely to the conveying direction into its position of readiness 26 by raising the platform.

Otherwise, a load-bearing unit 16 placed on the load-bearing means 12 of a trolley 21 in the transfer and pick-up area 27 can be drivingly linked to the load-bearing unit by raising height guide elements and the load-bearing element 16 forwarded directly to a despatch line by means of the trolley 21, for example. To provider a clearer understanding of how the load-bearing unit 16 is conveyed in the conveyor section 4; 6, for example, this procedure will be explained in more detail in connection with FIGS. 6 to 8.

At this stage, it is expressly pointed out that the layout of the order picking system 1 described here is merely given as an example and it would naturally be possible to operate one or more adjacently arranged conveyor trolleys 8 synchronously or non-synchronously between the racking bay 7 and at least one conveyor section 3; 4; 5; 6.

To provide a clearer understanding of the structure and function of the trolley 21, it will be described below with reference to the highly simplified diagrams of FIGS. 3 to 5 depicting different views. As illustrated in these drawings, the trolley 21 can be displaced on the load-bearing means 12, which, as mentioned above, can be moved in a vertical direction —as indicated by double arrow 28—along a mast of the conveyor trolley, which is not visible in this drawing.

The trolley 21 essentially consists of a support frame 29, part of which is provided with a base to accommodate other components, with bogie assemblies 30 to the side of its support frame 29 in the direction of its longitudinal extension. Each of the bogie assemblies 30 has several height guide elements 31, in particular guide rollers, adjacently disposed in a row one after the other and spaced at a distance apart transversely to the displacement motion —indicated by double arrow 24—, which sit on height guide tracks 32 so that they can roll, at least intermittently, the oppositely lying end regions of which are each provided with at least two lateral guide elements 33 which roll on lateral guide tracks 34.

The height guide elements, spaced equidistantly one after the other in the longitudinal extension, are provided in the form of guide rollers which rotate about axes disposed transversely to the displacement motion—indicated by double arrow 24—of the trolley 21, whilst the lateral guide elements 33 are provided in the form of guide rollers which rotate about axes disposed perpendicular to a transport plane 35 of the load-bearing means 12.

The height guide elements 31 at each longitudinal side are drivingly linked to one another by means of a chain, not illustrated, or are arranged in several groups in the direction of the displacement motion—indicated by double arrow 24. The height and lateral guide tracks 32, 34 are provided in the form of angled sections 22, the horizontal legs 37 of which, joined to a support frame 36 of the load-bearing means 12, constitute the height guide tracks 32 for the height guide elements 31, whilst the upwardly projecting legs 38 serve as the lateral guide tracks 34 for the lateral guide elements 33. The guide tracks 23 incorporating the height and lateral guide tracks are approximately L-shaped and are made from metal, at least in the region of the hardened sections 22 constituting the height and lateral guide tracks 32.

Two height guide elements 31 are partially linked to one another by means of a common axis transversely to the displacement motion—indicated by double arrow 24. Consequently, some of the height guide elements 31 may be linked to the support frame 29 by nothing more than stub axles. The trolley 21 is provided with at least one displacement drive 39 supported on the support frame 29 to produce the displacement motion—indicated by double arrow 24—triggered by the conveyor trolley 8, in particular the load-bearing means 12, along the sections in the racking bay or sections 22 in the transfer and pick-up area, and the drive connection between the displacement drive 39 and the bogie assemblies 30 displaces the height guide elements 33 thereof or only individual groups of height guide elements 33 in a rotating motion, so that the trolley 21 can be displaced relative to the load-bearing means 12 whilst being guided in the height direction and to the side. The displacement drive 39 has a controllable drive motor, in particular a stepper motor or servo motor, providing a simple means of regulating the rotation speed of the synchronously driven height guide elements 31 by appropriate programming. Naturally, synchronous or asynchronous motors could also be used as the displacement drive 39 with an inter-connected gear system.

Naturally, another option would be to use the bogie assemblies 30 exclusively as a means of transmitting load via the height guide elements to the height guide tracks 32, in which case the displacement motion—indicated by double arrow 24—is generated by means of a displacement drive 39 totally independent of the bogie assembly 30, which would then be connected to several drive elements arranged in a single row one after the other, so that the torque applied to the trolley 21 is converted into a displacement motion—indicated by double arrow 24.

As may be seen from the drawings, the trolley 21 has at least one platform 40, which is actively connected to a drive 41 supported on the support frame 29, which effects a lifting and lowering motion relative to the bogie assemblies 30 in a direction substantially perpendicular to the transport plane 35. The platform 40 is disposed on the support frame 29 of the trolley carriage 21 and the platform 40 can be raised and lowered by means of at least one drive mechanism 42 disposed between it and the support frame 29. A lift mechanism 42 of this type can be set up using any actuator drives known from the prior art that would permit a relative displacement between the platform 40 and the bogie assembly 30, such as a pneumatic, hydraulic, or electric drive or lifting and lowering slide elements, for example. In the embodiment illustrated as an example here, the lifting mechanism 42 is provided in the form of a crank system. It has several toggle-type transmission elements 43, 43′, 44, 44′ for converting the rotary motion of the drive 41 into a raising and lowering motion for the platform 40. At least one drive flange 45 is articulatingly linked to two transmission elements 43, 44 joined to one another by an articulated joint 46 in the form of a toggle system, in which the free end of the transmission element 44 is in turn attached to the support frame 29 in an articulating arrangement.

More or less in the centre region of the transmission element 44, extending between the support frame 29 and the articulated joint 46, is a positioning lever 47 extending from the centre region at an angle towards the transmission element 44 and linked to the platform 40 in an articulating arrangement offset from the articulated joint 46. The articulated joint 46 is linked via the other transmission element 43′, which extends at an angle to the transmission element 43, to another articulated joint 46′, which is disposed on another transmission element 44′, also articulatingly secured to the support frame 29. The transmission elements 44, 44′ are disposed in symmetrical mirror image relative to one another. Due to the fact that the transmission elements 43, 43′ are arranged eccentrically on the drive flange 45 or adjoining the drive flanges 45, the position of the platform 40 will be maintained when the latter are rotated, depending on whether it is in a raised, upper position, as illustrated in FIG. 4, or in a bottom, lowered position as illustrated in FIG. 3. The platform 40 is displaced relative to the load-bearing means 12 in a direction essentially perpendicular to the transport plane 35 of the load-bearing means 12.

FIGS. 6 and 7, which will be described together, illustrate a side view of the transfer and pick-up area 27 with a part-section of the load-bearing means 12 and the load-bearing unit 16 disposed in this area, FIG. 6 depicting the load-bearing unit 16 in a conveying position and FIG. 7 depicting the load-bearing unit 16 placed in a non-operating position relative to the load-bearing means 12. As may be seen from these drawings, two parallel and synchronously controlled trolleys 21 are assigned to the load-bearing unit 16 in the direction of its width 19 in order to pick up a load-bearing unit 16, in particular a pallet 17, as and when necessary, which are synchronously displaceable in the direction of the displacement motion—indicated by double arrow 24—along the guide tracks 23, in particular the height and lateral guide tracks 32, 34, on the load-bearing means 12 and the sections 22 of the stowage space 15, whilst providing a height and lateral guiding action. Any synchronisation systems known from the prior art may be used fort his purpose. As described above, the trolleys 21 each have the platform 40 for accommodating the load-bearing unit 16, in particular the pallet 17, as and when required, as well as the bogie assemblies 30 at oppositely lying longitudinal sides, respectively provided with at least one displacement drive 39 to impart the displacement motion—indicated by double arrow 24—triggered by the load-bearing means 12. In the embodiment illustrated as an example here, the displacement drive 39 is provided in the form of the driveable height guide elements 31 of the bogie assemblies 30.

The drive 41 which effects a raising and lower motion relative to the bogie assemblies 30 substantially perpendicular to the transport plane 35 is not visible in this drawing.

As proposed by the invention, at least one displacement mechanism 48 co-operates with the bogie assemblies 30 and the height guide elements 31 and has a first non-operating position—illustrated in FIG. 7—in which the guide elements 31 of the trolley 21 are supported on the height guide tracks 32 of the sections 22, and at least one other conveying position—illustrated in FIG. 6—in which the height guide elements 33 are disengaged from the height guide tracks 32 of the sections 22, and the height guide elements are mounted so as to move or displace a load-bearing unit 16 via the displacement drive 39 as and when necessary by lifting or disengaging the height guide elements 31 from the height guide tracks 32. In the non-operating position, the trolley 21 is guided in displacement along the sections on the load-bearing means 12 or in the racking bay. Consequently, the load-bearing unit 16 and the height guide elements 31 sit in abutment with one another in the conveying position, so that support surfaces 49 of longitudinal spars 50 of the load-bearing unit 16 and external faces of the height guide elements 31 are in contact with one another, and at least one of the bogie assemblies 31 of each trolley 21 acts as a conveyor track, in particular a roller conveyor, for the trolley 21 in the transfer region 27. The rotation speed and hence the speed at which the load-bearing unit 16 is conveyed can be varied via an appropriate control system as required, by synchronously varying the drive speeds of the displacement drives 39 of the two trolleys 21. As also illustrated in FIG. 6, an arrangement of this type has a major advantage in that, because the load-bearing unit 16 is supported by the height guide elements 31 when in the conveying position, its middle region is also able to take and transport heavy loads.

Naturally, it would also be possible, within the scope of the invention, to provide more than one, for example two, trolleys 21 transversely to the direction of the displacement motion—indicted by double arrow 24—adjacent to one another and/or one behind the other in the direction of the displacement motion—indicated by double arrow 24—if transporting wider and/or longer load-bearing units 16, such as a crate for example, in which case these will be electrically driven in synchronisation along the guide tracks 23 and sections 22 of the stowage spaces 15, guided in the height direction and to the side.

The displacement mechanism 48 is arranged on the load-bearing means 12 for the trolley 21 and is fitted with driver elements 51, schematically indicated by dotted-dashed lines, to link up to the trolley 21. The two trolleys 21 are held positioned on the load-bearing means 12 in the raised conveying position—see FIG. 6—by means of the driver elements 51, so that even load-bearing units 16 of a heavier weight can be transferred or manipulated without problems. When the trolley is in the lowered non-operating position—see FIG. 7—the driver elements 51 are disengaged from the trolley 21 and the two trolleys 21 can be operated synchronously and pushed by the load-bearing means 12 along the sections 22 of the racking bay 7 into the stowage spaces 15, and one or two load-bearing units 16 lying one behind the other brought down. Once the mutually adjacent trolleys 21 have lowered at least one load-bearing unit 16 transversely to the direction of displacement motion—indicated by double arrow 24—the platforms 40 of the trolleys 21 are synchronously raised and at least one load-bearing unit 16 is lifted off the sections 22 of the stowage space 15 and conveyed onto the load-bearing means 12. The load-bearing unit 16 is supported on the platforms 40 during the displacement motion of the trolleys 21. In order to effect the synchronous displacement motion—indicated by double arrow 24—and the lifting motion —indicated by double arrow 52—the two displacement drives 39 as well as the two drives 41 for effecting the raising and lowering motion of the trolleys 21 are driven in synchronisation with one another so that the trolleys 21 co-operate with one another in pairs. The electric coupling of the two displacement drives 39 is provided in the form of a synchronisation control so that the two trolleys 21 are always at the same height on the load-bearing means 12 and in the stowage spaces 15 during the displacement motion—indicated by double arrow 24—along the sections 22, so that one load bearing unit 16—as illustrated in FIGS. 6 and 7—or several of them—not illustrated—, preferably two load bearing units 16 lying one after the other in the direction of displacement motion—indicated by double arrow 24—can be picked up jointly. A lifting direction—indicated by double arrow 52—extends more or less perpendicular to the transport plane 35 of the load-bearing means 12 and preferably substantially parallel with the displacement mechanism—as indicated by double arrow 28. In the embodiment illustrated as an example here, the displacement mechanism 48 is provided in the form of crank system 54 with toggle-type push rods 55. The push rod 55 standing proud of the motor 53 is linked via an articulated joint 57 at the end lying opposite the motor 53 to other push rods 55′ and a lifting element 57, in the form of a toggle, articulatingly joined to one another, it being preferable for the lifting element 57 to be mounted off-centre from the load-bearing means 12 and secured by its free end region to a lifting table 58. The articulated joint 56 is linked via another push rod 55′ extending parallel with the transport plane 35 to another push rod 55′ with an articulated joint 56′, disposed on another lifting element 57′ secured to the load-bearing means 12 in an articulating arrangement. Since the pivot axes of the lifting elements 57, 57′ are fixed relative to the load-bearing means 12, the lifting table 58 is designed so that it can be adjusted to a different angle or approximately perpendicular to the transport plane 35. Consequently, the crank system 54 converts a linear pushing motion of the push rods 55, 55′ into a lifting or lowering motion or displacement of the lifting table 58 relative to the load-bearing means 12.

When this embodiment is in a conveying position, the two adjacent trolleys 21 are lifted off the guide tracks 23 above the lifting table 58 simultaneously and moved into engagement with the support surfaces 49 of the load-bearing unit 16. When in a raised conveying position, the lifting table 58 and the trolley 21 can be positioned relative to one another and released by means of opposite positioning means, such as positioning pins fixed on the lifting table 58, which can be electrically or pneumatically or hydraulically displaced.

Instead of using the crank system 54 with its mechanical design, it would of course also be possible to use appropriate pressure-operated actuators such as a pneumatic or hydraulic drive, for example, or electrically powered actuators.

Although not specifically illustrated, it would also be possible for the displacement mechanism 48 to serve additionally as the drive 41 for raising and lowering the platform 40 and to provide appropriate means, such as punch-type support elements, between the support frame 29 and the load-bearing means 12 to disengage the bogie assembly 30 from the height guide track 32.

As explained above, the height guide elements 31 or guide rollers are rotatable about a horizontal axis and are joined to the support frame 29 of the trolley 21 so as to be stationary. As an alternative, it would also be possible for the bogie assemblies 30 or at least individual height guide elements 31 to be designed so as to be displaceable in the direction perpendicular to the transport plane 35, although this option is not illustrated, in which case a drive shaft for the drive element or elements 31 would be articulatingly linked to the support frame 29 via a universal joint axis or universal joint shaft, for example. This being the case, a displacement mechanism 48 will be provided between the height guide elements 31 and a support frame 29 of the trolley 21.

The displacement mechanism 48 co-operates with at least individual height guide elements 31 on one side of the trolley 21 or a respective pair of height guide elements 31 will be disposed in a same cross-sectional plane perpendicular to the longitudinal direction of the trolley 21. This provides a simple option of varying the number of driven height guide elements 31 of the trolley 21 and adapting to different types of load-bearing units 16 to be handled.

In another embodiment, not illustrated, the displaceable guide track 23 or the guide tracks 23 are disposed perpendicular to the transport plane 35 relative to a support frame 36 of the load-bearing means 12 and the displacement mechanism 48 is arranged between the guide track 23 or guide tracks 23 and the support frame 29 of the trolley 21.

As schematically indicated by broken lines in FIGS. 6 and 7, there also exists the possibility of providing support arms on the load-bearing means 12, projecting in the direction away from the transport plane 35 and co-operating with the support faces 49, in order to position and retain the trolley 21, preferably stationary in a pre-definable position and/or in a non-operating position. Optionally, these support arms 59 may be provided with support elements which can be extracted relative to the load-bearing means 12 in order to lift the load-bearing unit 16 off the load-bearing means 12 and guide tracks 23.

As also illustrated in FIG. 6, a minimum track width 60 between the height guide elements 31, arranged at a distance apart in parallel, rows is at least slightly bigger than a minimum clearance width 61 between two adjacent longitudinal spars 50 of the load-bearing unit 16 and the maximum track width 60 is smaller than a maximum clearance width 61. Leaving a space free between the platform 40 and a bottom face 62 of the load-bearing unit in the conveying position affords a more reliable driving connection between the height guide elements 31 and the load-bearing unit 16.

Although not specifically illustrated, the trolley 21 may have a separate power supply unit, in particular a rechargeable battery, or an electrical and/or mechanical clutch mechanism. When the trolley 21 is in a pre-definable stand-by position on the load-bearing means 12, the clutch mechanisms and a supply unit are connected to one another and power and/or control signals is or are transmitted by contacts to the trolley 21. The supply unit may incorporate eddy fields or other visible and/or invisible energy fields, such as optical fields, magnetic fields or similar, for example photoelectric elements. The power and/or data and/or signals are transmitted between the conveyor trolley 8 and the trolley 21 via connecting lines.

It should be pointed out that the height guide elements 31 and/or the lateral guide elements 33 of the trolley 21 are made from elastomer, preferably thermoplastic materials, or steel encased in plastic, which enables a high coefficient of friction to be obtained in co-operation with a pallet 17 made from wood, thereby permitting high rotation speeds and feed rates.

It should also be pointed out that it would naturally also be possible to fit a support frame 29 of the trolleys 21 with several platforms 40 which can be raised and lowered by means of a displacement mechanism 48, a pallet 17 being assigned to the platforms 40.

FIG. 8 is a highly simplified, schematic diagram illustrating a side view of one example of an embodiment of the transfer and pick-up area 27 between two conveyor sections 4 arranged spaced apart by at least the distance of the racking aisle and the trolley 21 transported by the conveyor trolley 8. The conveyor sections 4 in this embodiment are provided in the form of a conveyor mechanism 63, in particular a roller conveyor. The conveyor trolley 8 has load-bearing means 12 which are displaceable in the height direction of the mast 13—as indicated by double arrow 28. The conveyor trolley 8 is expediently provided as the shelf stacking device 9 described above and is displaceable in the aisle direction along a track 10 supported on a standing surface 64. In the embodiment illustrated as an example here, the two adjacent trolleys 21 are disposed on the load-bearing means 12 in their conveying positions, in which the height guide elements 31 of the bogie assemblies 30 are disengaged and raised off the height guide tracks 32 of the guide track 23. The platforms 40 of the trolleys 21, indicated by dotted-dashed lines in FIG. 8, are aligned parallel with one another and extend parallel with the transport plane of the load-bearing means 12 in the conveying position and are positioned between the longitudinal spars 50. In this conveying position, the height guide elements 31, on the longitudinal sides of the trolley 21, at least some of which may be driven, are drivingly linked to at least one load-bearing unit 16. As described above, the height guide elements 31 are drivingly linked to the conveyor sections 4 by means of a displacement drive, not illustrated, during the time a first or other load-bearing units 16 are being fed and/or transferred. As a result of the rotary motion or drive connection of the height guide elements 31 to two load-bearing units 16 (as illustrated in this drawing), the first load-bearing unit 16 is pushed off the trolley 21, as indicated by arrow 24, in the direction of its length 18 onto the other conveyor section 4 downstream of the conveyor trolley 8, in particular the despatch line, and another load-bearing unit 16 is simultaneously pushed by the first conveyor section 4 upstream of the conveyor trolley 8, in particular the incoming line, onto the trolley 21. Consequently, several load-bearing units 16 can be conveyed in timed sequence one after the other and can be so at least at a slight distance apart from one another by means of the trolley 21, which makes for a considerable saving in time, especially in the transfer and pick-up area 27, and in the broader sense improves the turnaround rate between several conveyor sections 4.

As illustrated, the rollers of the roller conveyor of the downstream other conveyor section 4 may be driven or not driven, and in the latter case, because the load-bearing unit 16 is displaced—as indicated by arrow 24—on the roller conveyor, it can be pushed off and the non-driven rollers thereof displaced in a rotating motion. The rollers of the roller conveyor of the first conveyor section 4 are preferably driven and a feed rate of the first conveyor section 4 is synchronous with and in the same direction as the feed rate of the height guide elements 31.

The rows of height guide elements 31 arranged in rows one after the other on the longitudinal side of the trolley 21 each form a conveyor track 65 for at least one load-bearing unit 16 in the conveying position. A conveyor plane 66 of conveyor mechanisms 63 immediately adjacent to the trolleys 21 extend flush with a conveyor plane 67 containing the conveyor tracks 65 of the trolley 21. When the transport carriages 21 are in the conveying position, as illustrated in this drawing, a guide plane 67 containing the raised height guide elements 31 for the load-bearing unit extends parallel with a horizontal conveyor plane of conveyor sections 4 receiving and despatching load-bearing units 16 disposed in alignment with one another.

The displacement drive of the trolley 21 and/or drives of the immediately adjacent conveyor mechanisms 63 co-operate with a common control system incorporating sensors 68, in particular limit switches, arranged in the region of the trolley 21 and/or the guide mechanisms 63, so that activation of the sensor 68 between the conveyor tracks 65 and the immediately adjoining conveyor mechanism 63 by a first load-bearing unit 16 will activate the drive of the other conveyor mechanism 63, prompting a transfer of a load-bearing unit 16 onto the trolley 21 immediately or when the first load-bearing unit 16 has left the conveyor track 65.

Once the load-bearing unit 16 has been pushed onto the other conveyor section 4 or been picked up from the first conveyor section 4, the height guide elements 31 are lowered, as described above in connection with FIG. 7, and are placed on the height guide tracks 32 of the section 22 on the load-bearing means 12 where they can roll. The conveyor trolley 8 then travels to another transfer and pick-up area 27 or is positioned in readiness for storing or retrieving a pallet 17 from the racking bay 7.

Naturally, the feed rate of the displacement drives used to move several load-bearing units 16 may be the same or different, both during the pushing on and during the pushing off process.

For the sake of good order, it should finally be pointed out that in order to provide a clearer understanding of the structure of the conveyor trolley and the trolley, they and their constituent parts are illustrated to a certain extent out of scale and/or on an enlarged scale and/or on a reduced scale.

The underlying objective and independent solutions proposed by the invention may be found in the description.

Above all, the embodiments of the subject matter illustrated in FIGS. 1, 2; 3, 4, 5; 6, 7; 8 may be construed as independent solutions proposed by the invention in their own right. The objectives and associated solutions may be found in the detailed descriptions of these drawings.

List of reference numbers

| | |
|---|---|
| 1 | Order picking system |
| 2 | Conveyor section |
| 3 | Conveyor section |
| 4 | Conveyor section |
| 5 | Conveyor section |
| 6 | Conveyor section |
| 7 | Racking bay |
| 8 | Conveyor trolley |
| 9 | Shelf stacking device |
| 10 | Track |
| 11 | Double arrow |
| 12 | Load-bearing means |
| 13 | Mast |
| 14 | Shelf |
| 15 | Stowage space |
| 16 | Load-bearing unit |
| 17 | Pallet |
| 18 | Length |
| 19 | Width |
| 20 | Depth |
| 21 | Trolley |
| 22 | Section |
| 23 | Guide track |
| 24 | Double arrow |
| 25 | Preliminary zone |
| 26 | Position of readiness |
| 27 | Transfer and pick-up area |
| 28 | Double arrow |
| 29 | Support frame |
| 30 | Bogie assembly |
| 31 | Height guide element |
| 32 | Height guide element |
| 33 | Lateral guide element |
| 34 | Lateral guide element |
| 35 | Transport plane |
| 36 | Support frame |
| 37 | Leg |
| 38 | Leg |
| 39 | Displacement drive |
| 40 | Platform |
| 41 | Drive |
| 42 | Lifting mechanism |
| 43 | Transfer element |
| 43′ | Transfer element |
| 44 | Transfer element |
| 44′ | Transfer element |
| 45 | Drive flange |
| 46 | Articulated joint |
| 46′ | Articulated joint |
| 47 | Actuator lever |
| 47′ | Positioning lever |
| 48 | Displacement mechanism |
| 49 | Support surface |
| 50 | Longitudinal spar |
| 51 | Driver element |
| 52 | Double arrow |
| 53 | Motor |
| 54 | Crank system |
| 55 | Push rod |
| 55′ | Push rod |
| 56 | Articulated joint |
| 56′ | Articulated joint |
| 57 | Lifting element |
| 57′ | Lifting element |
| 58 | Lifting table |
| 59 | Support arm |
| 60 | Track width |
| 61 | Width |
| 62 | Bottom face |
| 63 | Conveyor mechanism |
| 64 | Standing surface |
| 65 | Conveyor track |
| 66 | Guide plane |
| 67 | Guide plane |
| 68 | Sensor |

1. Conveyor trolley, in particular a shelf stacking device, with a load-bearing means to accommodate a trolley having a platform for receiving a load-bearing unit, in particular a pallet, as and when necessary, which is equipped with bogie assemblies with height and lateral guide elements for storing and retrieving the load-bearing unit, and the height guide elements are displaceable along at least one guide track on the load-bearing means in a transport plane extending substantially perpendicular to the height and/or lateral guide track of the load-bearing means and are linked to at least one displacement drive for initiating the displacement motion of the load-bearing means, and the platform is linked to a drive which effects a lifting and lowering motion relative to the bogie assemblies substantially perpendicular to the transport plane, characterised in that the height guide elements (31) co-operate with at least one displacement mechanism (48), which has a first non-operating position in which the height guide elements (31) of the trolley (21) are supported on the height guide tracks (32), and at least one other conveying position, in which the height guide elements (31) are disengaged from the height guide tracks (32), and the height guide elements (31) displaceably bear and support at least one load-bearing unit (16) by means of the displacement drive (39) as and when necessary.

2. Conveyor trolley as claimed in claim 1, wherein the displacement mechanism (48) for the trolley (21) is disposed on the load-bearing means (12) and has driver elements (51) in order to connect with the trolley (21), and a lifting direction (52) extends substantially perpendicular to the transport plane (35).

3. Conveyor trolley as claimed in claim 1, wherein the displacement mechanism (48) is disposed between the height guide elements (31) and a support frame (29) of the trolley (21) and has a lifting direction (52) extending substantially perpendicular to the transport plane (35).

4. Conveyor trolley as claimed in claim 1, wherein the displacement mechanism (48) co-operates with at least individual ones of the height guide elements (31) on a longitudinal side of the trolley (21).

5. Conveyor trolley as claimed in claim 1, wherein the displacement mechanism (48) co-operates respectively with a pair of height guide elements (31) in a same cross-sectional plane perpendicular to the longitudinal direction of the trolley (21).

6. Conveyor trolley as claimed in claim 1, wherein the height guide tracks (32) are provided in the form of section-type guide tracks (23) and the guide tracks (23) are displaceable perpendicular to a transport plane (35) relative to a support frame of the load-bearing means (12), and the displacement mechanism (48) is disposed between the guide tracks (23) and the support frame of the load-bearing means (12).

7. Conveyor trolley as claimed in claim 1, wherein fixed support arms (59) are provided on the load-bearing means (12) in order to retain the trolley (21), preferably in a pre-definable position or in the conveying position.

8. Conveyor trolley as claimed in claim 1, wherein the support arms (59) for the trolley (21) are disposed on the load-bearing means (12) so as to be displaceable in the direction extending perpendicular to the transport plane (35), and the displacement mechanism (48) is disposed between the latter and the load-bearing means (12).

9. Conveyor trolley as claimed in claim 1, wherein the adjacent height guide elements (31) spaced at a distance apart constitute conveyor tracks (65) for the load-bearing unit (16) in their conveying position, and a conveyor plane (66) of each of the two terminal ends of conveyor tracks (65) of the trolley (21) of immediately adjacent conveyor mechanisms (63) extends flush with a conveyor plane (67) of the conveyor tracks (65) when in the conveying position.

10. Conveyor trolley as claimed in claim 1, wherein the conveyor planes (66, 67) extend at an angle to a horizontal plane.

11. Conveyor trolley as claimed in claim 1, wherein the displacement drive (39) for the height guide element (31) of the trolley (21) is designed simultaneously to move an incoming and an outgoing load-bearing unit (16).

12. Conveyor trolley as claimed in claim 1, wherein the displacement mechanism (48) has a lifting table (58), which is designed to be displaceable relative to the load-bearing means (12) in a direction perpendicular to the transport plane (35) by means of a crank system (54), which can preferably be driven by means of a motor (53) with toggle-type push rods (55, 55′).

13. Conveyor trolley as claimed in claim 12, wherein the push rods (55, 55′) are drivingly linked to lifting elements (57, 57′) parallel with the transport plane (35) and mounted about eccentric axes offset therefrom in the direction of the load-bearing means (12).

14. Conveyor trolley as claimed in claim 12, wherein the lifting table (58) of the crank system (54) supporting the trolley (21) in its raised conveying position is displacingly linked to the lifting elements (57, 57′), in order to convert a linear pushing motion of the push rods (55, 55′) into a lifting and lowering motion of the lifting table (58).

15. Conveyor trolley as claimed in claim 1, wherein the displacement mechanism (48) has a lifting table (58), each of its oppositely lying longitudinal sides being equipped with an endlessly circulating drive element, such as a belt or chain.

16. Conveyor trolley as claimed in claim 1, wherein the displacement mechanism (48) is the drive (41) for the lifting and lowering motion of the platform (40).

17. Conveyor trolley as claimed in claim 1, wherein the displacement drive (39) and/or the drive (41) for producing the lifting and lower motion and/or the displacement mechanism (48) is provided in the form of a pressure-operated actuator, such as a pneumatic or hydraulic drive, and the lifting table (58) is displaceable relative to the load-bearing means (12) by means of the actuator.

18. Conveyor trolley as claimed in claim 1, wherein the displacement drive (39) and/or the drive (41) for producing the lifting and lowering motion and/or the displacement mechanism (48) is provided in the form of an electrically operated actuator and the lifting table (58) is displaceable relative to the loading-bearing means (12) by means of the actuator.

19. Conveyor trolley as claimed in claim 1, wherein, at least when the trolley (21) is in the raised conveying position, the trolley (21) and the load-bearing unit (16) are positioned relative to one another in and transversely to the direction of the displacement motion (24) thereof.

20. Conveyor trolley as claimed in claim 1, wherein the platform (40) has a longitudinal guide track for laterally guiding the load-bearing unit (16), in particular when it is being transferred from the platform (40) to one of several conveyor sections (3; 4; 5; 6) adjacent to it.

21. Conveyor trolley as claimed in claim 1, wherein a longitudinal extension of the load-bearing unit (16), in particular the pallet (17), is aligned in the direction of the displacement motion (24) of the trolley (21), and a longitudinal extension of the trolley (21) extends parallel with the load-bearing unit (16) and transversely to the aisle direction (11) of the conveyor trolley (8).

22. Conveyor trolley as claimed in claim 1, wherein, when the displacement drive (48) is in the lowered non-operating position, longitudinal spars (50) running across a length (18) of the load-bearing unit (16) and spaced at a distance apart from one another are supported on the load-bearing means (12) by their support surfaces (49) remote from a loading surface and spaced at a distance apart therefrom.

23. Conveyor trolley as claimed in claim 1, wherein spacers run between the loading surface and longitudinal spars (50), which run transversely to the displacement motion (24) of the trolley (21), at a distance from and parallel with one another.

24. Conveyor trolley as claimed in claim 1, wherein a minimum track width (60) between the height guide elements (31) spaced apart in rows is slightly bigger than a minimum clearance width (61) between two adjacent longitudinal spars (50), and the maximum track width (60) is smaller than a maximum clearance width (61).

25. Conveyor trolley as claimed in claim 1, wherein the platform (40), which can be positioned between two adjacent longitudinal spars (50), is spaced at least slightly apart from a bottom face (62) of the load-bearing unit (16) in the other raised conveying position, and the support surfaces (49) of the longitudinal spars (50) are placed on the height guide elements (31).

26. Conveyor trolley as claimed in claim 1, wherein several, preferably two trolleys (21) are provided on the load-bearing means (12), which are preferably displaceable by means of height and lateral guide elements (31, 33) along height and lateral guide tracks (32, 34) disposed thereon, and can be activated synchronously, in particular by means of a synchronised trolley (21), and the latter receives at least one or more load-bearing units (16) which can be sorted one after the other in the direction of the displacement motion (24) of the trolley (21).

27. Conveyor trolley as claimed in claim 1, wherein the stationary guide tracks (23) on the load-bearing means (12), which extend transversely to the aisle direction (11) of the conveyor trolley (8) and parallel with one another spaced apart by at least the track width (60), are provided in the form of angled sections (22) and horizontal legs (37) constitute the height guide tracks (32) for the height guide elements (31) and the guide rollers forming them, whilst the upright legs (38) constitute the lateral guide tracks (34) for the lateral guide elements (33) and the guide rollers forming them.

28. Conveyor trolley as claimed in claim 1, wherein, when the trolley (21) is in the lowered non-operating position, at least certain regions of the support surfaces (49) of the load-bearing unit (16) are supported on part-surfaces of the guide tracks (23), in particular the upright legs (37).

29. Conveyor trolley as claimed in claim 1, wherein, in its raised conveying position, the lifting table (58) is releasably connected to the trolley (21) by means of opposite positioning elements and driver elements (51), such as coupling pins.

30. Conveyor trolley as claimed in claim 1, wherein the trolley (21) has a separate power supply unit, in particular a rechargeable battery.

31. Conveyor trolley as claimed in claim 1, wherein the trolley (21) has an electric and/or mechanical clutch mechanism and when the trolley (21) is in a pre-definable stand-by position on the load-bearing means (12), the clutch mechanism and a power supply unit are actively connected, in particular plugged in, in order to transmit energy and/or control signals.

32. Conveyor trolley as claimed in claim 1, wherein the power supply unit has eddy fields or other visible or invisible energy fields, such as optical, magnetic fields or similar, and incorporates photoelectric elements, for example.

33. Conveyor trolley as claimed in claim 1, wherein the trolley (21), in particular the displacement drive (39), the drive (41) for producing the lifting and lowering motion and control unit are connected via a connecting line for transmitting data and/or signals and/or power to a supply unit and control unit provided on the conveyor trolley (8).

34. Conveyor trolley as claimed in claim 1, wherein the height guide elements (31) of the trolley (21) are made from elastomer, preferably a thermoplastic, or from steel encased in plastic.

35. Method of storing and/or retrieving pallets from a racking bay with a conveyor trolley, in particular a shelf stacking device co-operating with a load-bearing means which is adjustable in height and into the individual stowage positions in order to despatch or pick up a load-bearing unit, and a trolley on the load-bearing means which is moved along at least one guide track and by means of which the load-bearing unit is transferred and picked up or despatched for ultimate storage or despatch, the trolley being guided by means of height guide elements, in particular guide rollers, on the at least one guide track, in particular as claimed in claim 1, wherein the height guide elements are optionally supported so that they roll on the guide track in order to effect a displacement relative to the load-bearing means or, if the trolley is in a fixed position on the load-bearing means, are supported on the load-bearing unit, and in order to push the load-bearing unit along relative to the trolley or relative to the guide track, a pushing motion of the displacement drive is transmitted to the height guide elements.

36. Method of storing and/or retrieving pallets from a racking bay with a conveyor trolley, in particular a shelf stacking device, co-operating with a load-bearing means which is adjustable in height and into the individual stowage positions in order to despatch or pick up a load-bearing unit, and a trolley on the load-bearing means which is moved along at least one guide track and by means of which the load-bearing unit is transferred and picked up or despatched for ultimate storage or despatch, the trolley being guided by means of height guide elements, in particular guide rollers, on the at least one guide track, in particular as claimed in claim 35, wherein the trolley is positioned between two conveyor mechanisms immediately adjoining the guide tracks at the end terminal ends thereof, after which the height guide element of the trolley is moved into a conveying position in order to engage with the load-bearing units, and then the first load-bearing unit is moved by means of the displacement drive of the height guide element in the direction of one of the conveyor mechanisms immediately downstream.

37. Method as claimed in claim 35, wherein, at the same time as or immediately after the load-bearing unit disposed on the trolley is moved in the direction of displacement by the displacement drive, another load-bearing unit is moved onto the trolley by the immediately adjacent conveyor mechanism disposed at the oppositely lying end.

38. Method as claimed in claim 35, wherein once the load-bearing unit to be moved by the trolley has left or almost left the conveyor track of the trolley, a load-bearing unit is pushed on to the trolley by the conveyor mechanism downstream of the guide track at the other end.

39. Method as claimed in claim 35, wherein the feed rate of the displacement drive is the same when picking up and despatching several load-bearing units.

40. Method as claimed in claim 35, wherein the feed rate of the displacement drives or the height guide elements is higher when picking up or despatching a load-bearing unit.

41. Method as claimed in claim 35, wherein a common control mechanism co-operates with the displacement drive of the trolley and/or drives of the immediately adjacent conveyor mechanisms, and sensors, in particular limit switches, are disposed in the region of the trolley and/or the conveyor mechanisms, and when the sensor is activated, the drive of the other conveyor mechanism between the conveyor tracks and the immediately adjacent conveyor mechanism is activated by a first load-bearing unit in order to transfer a load-bearing unit onto the trolley immediately or when the first load-bearing unit has left the conveyor track.
